(19) United States
(12) Patent Application Publication
(10) Pub. No.: US 2010/0316912 A1
(43) Pub. Date: Dec. 16, 2010

(54) SEPARATOR FOR POWER STORAGE DEVICE

(75) Inventors: Takeshi HASHIMOTO, Shizuoka-shi (JP); Hiroki TOTSUKA, Shizuoka-shi (JP); Masanori TAKAHATA, Shizuoka-shi (JP); Mitsuyoshi TAKANASHI, Shizuoka-shi (JP); Yasuhiro OOTA, Fujieda-shi (JP); Kazuhiko SANO, Shizuoka-shi (JP)

Correspondence Address: WOOD, HERRON & EVANS, LLP, 2700 CAREW TOWER, 441 VINE STREET, CINCINNATI, OH, 45202, US

(73) Assignee: Tomoegawa Co., Ltd., Tokyo (JP)

(21) Appl. No.: 12/796,860

(22) Filed: Jun. 9, 2010

(30) Foreign Application Priority Data
Jun. 11, 2009 (JP) 2009-139756
Jul. 10, 2009 (JP) 2009-164053
May 26, 2010 (JP) 2010-120714

(51) Int. Cl. H01M 2/16; H01M 2/14

(52) U.S. Cl. 429/254; 429/247

(57) ABSTRACT

This invention is relates to a separator of a power storage device which is a laminate of a polyolefin porous membrane layer and a fiber layer comprising a solvent spun cellulose; and a separator of a power storage device, wherein the separator is a laminate of a polyolefin porous membrane layer and a fiber layer comprising a solvent spun cellulose, and the volume of a cavity part of the fiber layer is smaller than the volume of a resin part of the polyolefin porous membrane layer.

### BACKGROUND OF THE INVENTION

1. Field of the Invention

The present invention relates to a separator for a power storage device (hereinafter, referred to as a separator) such as a lithium-ion rechargeable battery, a lithium ion capacitor or an electric double-layer capacitor.

Priority is claimed on Japanese Patent Application No. 2009-139756, filed Jun. 11, 2009, Japanese Patent Application No. 2009-164053, filed Jul. 10, 2009, and Japanese Patent Application No. 2010-120714, filed May 26, 2010, the content of which is incorporated herein by reference.

2. Description of Related Art

A power storage device such as a lithium-ion rechargeable battery, a lithium ion capacitor or an electric double-layer capacitor is equipped with a pair of electrodes and a separator, and an electrolyte is impregnated in the power storage device which is used for driving the power storage device. Such a power storage device has been used in a variety of industrial and household electrical and electronic devices.

In order to improve performance of electrical and electronic devices, it is essential to achieve higher capacity and higher performance of power storage devices. Therefore, further improvement of a separator is required. For example, in order to satisfy higher capacity of a power storage device, a separator is required which has dimensional stability, mechanical strength and heat resistance, and can endure against self-heating during charging and discharging and against overheating when being over-charged. In order to enable high performance of a power storage device, particularly, in order to enable increase of quick charge and discharge characteristics, and high power output characteristics, there is a strong demand for a thinner separator wherein the uniformness thereof is improved.

In order to satisfy the above requirements, for example, WO 01/67536 proposes the use of a film having increased air permeability as a separator, wherein the film is formed by providing through-holes by needle or laser in a microporous film (stretched film) having excellent air permeability wherein the microporous film is prepared by drawing polyolefin. However, there is a problem such that short-circuiting between a positive electrode and a negative electrode may be caused due to the presence of the through-holes in the separator when such a microporous film is used singly as a separator. Furthermore, such a film has characteristics such that the film easily shrinks at the range of the meltdown temperature (the range of melting temperature of a separator), which is higher than the shutdown temperature (the temperature wherein the holes and pores are closed). Therefore, problems may be caused such that utilized electrodes directly contact with each other, when the temperature increases. In order to achieve heat-shrinking resistance and mechanical strength in a separator while the separator is a thin film, it may be possible to decrease the void fraction of a separator. However, such a decreased void fraction causes an increase of internal resistance and a decrease of ionic conductivity. Therefore, demand for higher performance power storage devices cannot be satisfied.

For example, a separator having a shutdown function and a meltdown resistance property is proposed in Japanese Unexamined Patent Application, First Publication No. 2007-48738. The separator is formed by laminating, via an adhesive, a polyolefin porous membrane and a substrate having air permeability which consists of polyethylene terephthalate, polybutylene terephalate, polyamide, polyphenylene sulfide or the like. However, such a separator cannot achieve the demand for high performance as follows. When a polyethylene terephthalate or a polybutylene terephalate is used for the substrate, the substrate itself tends to easily melt at the meltdown temperature. When polyamide or polyphenylene sulfide is used for the substrate, it is difficult to form a thin film substrate, and internal resistance increases and ionic conductivity decreases.

### SUMMARY OF THE INVENTION

### Problem to be Solved by the Invention

The present invention provides a separator which is a thin film, has a shutdown function, and has excellent thermal shrinkage resistance, mechanical strength and ionic conductivity.

### Means for Solving the Problems

The first aspect of the present invention is a separator which is a laminate of a polyolefin porous membrane layer and a fiber layer comprising a solvent spun cellulose.

The second aspect of the present invention is a separator which is a laminate of a polyolefin porous membrane layer and a fiber layer comprising a solvent spun cellulose, wherein the volume of a cavity part of the fiber layer is smaller than the volume of a resin part of the polyolefin porous membrane layer.

The first and second aspects suitably have following characteristics. The fiber layer preferably contains a thermoplastic synthetic fiber A (hereinafter, referred to as a “fiber A”).

The fiber layer preferably contains a heat resistance synthetic fiber B (hereinafter, referred to as a “fiber B”).

The solvent spun cellulose is preferably a fibrillated cellulose having a fiber diameter of 1 μm or less and a fiber length of 3 mm or less.

The fiber A is preferably polyester or polyolefin.

It is preferable that the fiber layer has a compounding ratio of 70 to 95% by mass of the solvent spun cellulose and 5 to 30% by mass of the thermoplastic synthetic fiber A.

It is preferable that the fiber A has a fiber diameter of 5 μm or less and a fiber length of 10 mm or less.

It is preferable that the fiber B is made of at least one material selected from the group consisting of fully aromatic polyamide, semi-aromatic polyamide, fully aromatic polyester, polyphenylene sulfide, poly-p-phenylene-benzobisoxazole, polyimide, polyamide-imide, polyether ether ketone, polybenzimidazole and polyacetal.

It is preferable that a compounding ratio of the fiber layer is 5 to 90% by mass of the solvent spun cellulose, 5 to 30% by mass of the fiber A and 5 to 90% by mass of the fiber B.

It is preferable that the fiber B is a fibrillated fiber having a fiber diameter of 1 μm or less and a fiber length of 10 mm or less.

The thickness of the fiber layer is preferably 30 μm or less.

The density of the fiber layer is preferably 0.2 to 0.9 g/cm³.

The air permeability of the fiber layer is preferably 100 sec/100 ml or less.

The polyolefin porous membrane layer is preferably made of polyethylene and/or polypropylene.

It is preferable that a separator of the present invention is formed by adhering the fiber layer and the polyolefin porous membrane layer with an adhesive.

The power storage device including the separator of the present invention has excellent characteristics, and the power storage device is preferably used as a lithium-ion rechargeable battery, a lithium ion capacitor and an electric double-layer capacitor.

### DETAILED DESCRIPTION OF THE INVENTION

While preferred examples of the invention are described below, it should be understood that the invention is not to be considered as being limited by the examples. Additions and modifications of number, position, size, value and the like can be made in so long as the description is does not depart from the scope of the invention.

The first aspect of the present invention is a laminate wherein a polyolefin porous membrane layer and a fiber layer comprising solvent spun cellulose are combined, preferably via an adhesive. Accordingly, it is possible to provide a separator which has an excellent shutdown function and has excellent thermal shrinking resistance, mechanical strength and ionic conductivity.

The second aspect of the present invention is a laminate wherein a polyolefin porous membrane layer and a fiber layer comprising solvent spun cellulose are combined, preferably via an adhesive. Accordingly, it is possible to provide a separator which has a shutdown function and has excellent thermal shrinking resistance, mechanical strength and ionic conductivity. Furthermore, since the volume of a cavity part of the fiber layer is controlled to be smaller than the volume of a resin part of the polyolefin porous membrane layer, no cavity of the fiber layer remains after the polyolefin porous membrane layer melts in or over the meltdown temperature range and the melted resin is adsorbed in the cavity part of the fiber layer. Accordingly, it is possible to provide a separator which does not cause a decrease of resistance originating from a remaining cavity of the fiber layer after meltdown. If the volume of a cavity part of the fiber layer is larger than the volume of a resin part of the polyolefin porous membrane layer, an unfilled cavity part remains in a cavity part of a fiber layer after the polyolefin porous membrane layer melts in and over the meltdown temperature range and the melted resin is adsorbed by the cavity part of the fiber layer. Therefore, ionic conduction is restarted due to the unfilled part, and a shutdown function of the separator is inhibited.

In the present invention, the shutdown function means a characteristic that, an over current flow is stopped in a battery or the like due to closing of separator's openings, which are closed by the thermal deformation, when the battery is heated due to an overflow current. The meltdown temperature generally means the temperature that thermal shrinking of a film occurs to generate large holes in the film when the temperature exceeds the temperature at which a shutdown function is exhibited. On the other hand, in the present invention, the meltdown temperature means the temperature at which a polyolefin porous membrane layer starts to melt. The separator of the present invention has the double layered structure, and therefore, even when a polyolefin porous membrane layer begins to melt at the meltdown temperature, such a large hole as described above is not generated due to the presence of a fiber layer of the separator.

In the second aspect of the present invention, the volume of a cavity part of a fiber layer comprising solvent spun cellulose is determined using following formula (1).

The volume of a cavity part of a fiber layer (cm³)=L×W×T1×[1−(M/T2)/D] (1)

(Length of a fiber layer sheet: L (cm), width of a fiber layer sheet: W (cm), thickness of a fiber layer sheet: T1 (cm), basis weight of a fiber layer sheet: M (g/cm²), thickness of a fiber layer sheet: T2 (cm), and specific gravity of a fiber: D)

In the second aspect of the present invention, the volume of a resin part of the polyolefin porous membrane layer is determined using the following formula (2).

The volume of a resin part of a polyolefin porous membrane layer (cm³)=L×W×T1×[(M/T2)/D] (2)

(Length of a polyolefin porous membrane layer: L (cm), width of a polyolefin porous membrane layer: W (cm), thickness of a polyolefin porous membrane layer: T1 (cm), basis weight of a polyolefin porous membrane layer: M (g/cm²), thickness of a polyolefin porous membrane layer: T2 (cm), and specific gravity of a polyolefin: D)

In the first and second aspects of the present invention, it is preferable that the fiber layer includes a fiber A. It is further preferable that a fiber B is also included in the fiber layer.

A separator of the first and second aspects of the present invention is a layered product of a polyolefin porous membrane layer and a fiber layer comprising solvent spun cellulose, which are preferably joined with an adhesive, and the separator has improved impregnating ability with respect to an electrolyte. In the present invention, it is preferable that solvent spun cellulose fibrillated to fine fibers is used. Since such a fibrillated solvent spun cellulose has an excellent ability to impregnate an electrolyte and also achieves sufficient entanglement between fibers, a separator can be generated which has excellent heat-shrinking resistance and mechanical strength.

(Fiber Layer)

A fiber A can be selected optionally. For example, preferable examples of materials of the fiber include: polyesters such as polyethylene terephthalate, polybutylene terephthalate and fully aromatic polyarylate, and polyolefins such as polyethylene and polypropylene. Properties of the fiber A can be selected optionally. For example, it is preferable that the melting point of the fiber A is about 80 to 150° C., and the concentration of ionic impurities such as Na⁺, K⁺ and Cl⁻ is preferably about 0.01 to 0.1 ppm. A separator which has excellent mechanical strength can be obtained when a fiber layer including a fiber A is used.

A fiber B can be selected optionally. For example, examples of materials of the fiber include: fully aromatic polyamide, semi-aromatic polyamide, fully aromatic polyester, polyphenylene sulfide, poly-p-phenylene-benzobisoxazole, polyimide, polyamide-imide, polyether ether ketone, polybenzimidazole and polyacetal. They may be used singly or in combination of two or more. Since these materials are insoluble in an electrolyte used for driving, that is, insoluble in an electrolyte used which is used for driving a power storage device, it is possible that the fiber B made of such materials is fibrillated to form fine fibers.

When a fiber B is used in the fiber layer, durability regarding an electrolyte for driving a power storage device and durability under the high temperature conditions are improved. Therefore, it is possible to obtain a separator which has excellent thermal shrinking resistance and which hardly deteriorates even under the condition that the separator is used over a large period of time at the high temperature. Furthermore, when a fibrillated fiber B is used, it is possible to obtain a separator which has excellent retentivity and an impregnation ability regarding an electrolyte used for driving a power storage device. Such a separator is also excellent in mechanical strength since sufficient entanglement of fibers is achieved. Properties of a fiber B can be selected optionally, and for example, it is preferable that the glass transition temperature of a fiber B is about 200 to 350° C., and the concentration of ionic impurities such as Na⁺, K⁺ and Cl⁻ is preferably about 0.01 to 0.1 ppm.

The size of fibrillated solvent spun cellulose can be selected optionally. It is preferable that the fiber diameter of the cellulose is 1 μm or less, and the fiber length thereof is preferably 3 mm or less and still more preferably 1 mm or less. When the fiber diameter of the cellulose exceeds 1 μm and the fiber length thereof exceeds 3 mm, entanglement of fibers becomes insufficient, the mechanical strength of a separator tends to be small, and a sufficient electrolyte impregnating ability tends to not be obtained. The lower limit of the sizes of the cellulose can be selected optionally. Physical properties of the solvent spun cellulose can be selected optionally, and for example, it is preferable that the concentration of ionic impurities such as Na⁺, K⁺ and Cl⁻ is preferably about 0.01 to 0.1 ppm.

The size of a fiber A can be selected optionally in the present invention. The fiber diameter of a fiber A is preferably 5 μm or less and the fiber length thereof is preferably 10 mm or less. The fiber diameter of a fiber A is still more preferably 3 μm or less or less and the fiber length thereof is still more preferably 7 mm or less. When the fiber diameter of a fiber A exceeds 5 μm and the fiber length of a fiber A exceeds 10 mm, kinks tend to be generated in the fiber and texture unevenness is caused. The lower limit of the above characteristics can be selected optionally.

The size of a fiber B can be selected optionally in the present invention. The fiber diameter of a fibrillated fiber B is preferably 1 μm or less, and the fiber length of a fiber B is preferably 10 mm or less and still more preferably 1 mm or less. When the fiber diameter of a fiber B exceeds 1 μm and the fiber length of the fiber B exceeds 10 mm, entanglement between fibers tends to loosen, and mechanical strength tends to decrease. The lower limit of the above characteristics can be selected optionally.

When a fiber layer of the present invention includes a fiber A and solvent spun cellulose, the fiber A and the cellulose preferably satisfy the following compounding ratio. That is, it is preferable that they are included in the layer as a mixture such that the solvent spun cellulose is in an amount of 70 to 95% by mass and the fiber A is in an amount of 5 to 30% by mass. It is further preferable that the solvent spun cellulose is in an amount of 70 to 90% by mass, and the thermoplastic synthetic fiber A is in an amount of 10 to 30% by mass. When the amount of the fiber A is less than 5% by mass, a separator tends to be crushed toward the z axis. When the amount of the fiber A exceeds 30% by mass, heat-shrinking resistance of a separator tends to deteriorate since a fiber A tends to melt at a high temperature.

When a fiber layer of the present invention includes a fiber A, solvent spun cellulose and a fiber B, these components preferably satisfy the following compounding ratio. It is preferable that 5 to 90% by mass of solvent spun cellulose is included in the fiber layer. When the amount of the solvent spun cellulose is less than 5% by mass, entanglement between fibers becomes insufficient, the mechanical strength of a separator tends to decrease, and sufficient impregnating ability of an electrolyte is not achieved. When the amount of the solvent spun cellulose exceed 90% by mass, durability regarding an electrolyte for driving a power storage device tends to deteriorate in the condition of the high temperature atmosphere. It is preferable that 5 to 30% by mass of a fiber A is mixed in the fiber layer. When the amount of a fiber A is less than 5% by mass, a separator tends to be crushed toward z-axis, and when the amount of the fiber A exceeds 30% by mass, heat-shrinking resistance of a separator tends to deteriorate since a fiber tends to melt at the high temperature. It is preferable that 5 to 90% by mass of a fiber B is mixed in the fiber layer. When the amount of a fiber B is less than 5% by mass, it is difficult to control the opening diameter of a separator since the amount of fibrillated fine fibers is insufficient. When the amount of a fiber B exceeds 90% by mass, a separator becomes too dense since the amount of a fibrillated fine fiber becomes too large, and as the result, internal resistance tends to increase. It is more preferable that 70 to 90% by mass of solvent spun cellulose, 5 to 30% by mass of a fiber A, and 5 to 30% by mass of the fiber B is mixed in the layer.

In the present invention, the diameter of fine openings of the fiber layer including solvent spun cellulose can be optionally selected. It is preferable that the average opening diameter determined by Bubble Point Test is 0.1 μm or more, and more preferably 0.3 μm or more. The upper limit of the average opening diameter can be selected optionally, but it is about 1.0 μm or less in general. When the average opening diameter is less than 0.1 μm, internal resistance tends to increase since ionic conductivity decreases, and furthermore, manufacturing of a fiber layer tends to be difficult since it is hard to remove water. Here, the opening diameter determined by the Bubble Point Test can be obtained using a porometer manufactured by Seika Corporation (Product Name: Perm-Porpmeter, JIS K3832, ASTM F316-86) or the like.

A separator of the present invention has sufficient tensile strength and sufficient compressive strength. In order to further increase such strength, it is possible to mix a binder resin or a binder fiber to a fiber layer of the separator. The binder resin and the binder fiber can be selected optionally. Examples thereof include polyvinyl alcohol, polyacrylonitrile, and polyethylene and derivatives thereof. The examples can be used for the fiber layer, but the binder resin and the binder fiber are not limited to the cited examples.

The thickness of a fiber layer of the present invention is preferably 30 μm or less. When the thickness of the fiber layer exceeds 30 μm, it is difficult for a power storage device to decrease in thickness, the amount of an electrode material in a predetermined cell volume decreases, the capacity becomes small, and the resistance increases. Such a result is not preferable. The lower limit of the thickness can be selected optionally. In general, the lower limit thereof is about 5 μm or more.

Furthermore, the density of a fiber layer of the present invention is preferably 0.2 g/cm³ to 0.90 g/cm³, more preferably 0.25 g/cm³ to 0.85 g/cm³, and still more preferably 0.30 g/cm³ to 0.80 g/cm³. When the density of the fiber layer is less than 0.2 g/cm³, the volume of the cavity part of the fiber layer becomes too large, the impregnating amount of the electrolyte for driving a power storage device increases, and an increase in costs of the a power storage device may be caused. On the other hand, when the density of the fiber layer exceeds 0.90 g/cm³, the density of materials of the separator becomes too high, ion migration is inhibited, and the resistance tends to increase.

It is preferable that the air permeability of a fiber layer is 100 sec/100 ml or less. When the air permeability of the fiber layer is 100 sec/100 ml or less, it is possible to maintain suitable ionic conductivity. The air permeability described in the present invention is a value obtained with a Gurley type air permeability tester. The air permeability is preferably 50 or less. The lower limit thereof can be optionally selected. In general, the lower limit is about 0.1 or more.

(Polyolefin Porous Membrane Layer)

A polyolefin porous membrane layer has a lot of communicating holes which are uniformly provided in the layer. The holes connect one surface and the other surface of the membrane layer. The polyolefin porous membrane layer is not dissolved in an electrolyte, is a porous membrane, and has communicating holes. Therefore, the polyolefin porous membrane layer has a retentivity ability regarding an electrolyte, and ion in an electrolyte can transfer through the polyolefin porous membrane layer easily. Furthermore, when the temperature increases due to overcharging or overheating of a battery, the communicating holes can melt and close. Accordingly, it is possible to prevent thermal runaway caused by an electrochemical reaction, since a shutdown function can be performed when thermal runaway is caused by the electrochemical reaction. Physical properties of the polyolefin can be selected optionally. For example, melting point of the polyolefin is preferably about 120 to 140° C.

Polyolefin used in the polyolefin porous membrane layer can be selected optionally. For example, polyethylene, ethylene-α-olefin copolymer and polypropylene are cited. Examples of the polyethylene include low-density polyethylene and high-density polyethylene. Examples of the polypropylene include homo-polypropylene, a polypropylene block copolymer and a polypropylene random copolymer. These are used singly or in combinations of two or more. One type of, or two or more types of, the polymers may be included in one layer. When the polyolefin porous membrane layer is a plurality of layers, each of the plurality of layers may be formed with a different polyolefin. Among them, polyethylene and/or polypropylene are preferably used. When polyethylene and/or polypropylene are used as the polyolefin of the layer, it is possible to control an electrochemical reaction, since the porous membrane layer is melted at the temperature range (about 100 to 160° C.), wherein thermal runaway of the electrochemical reaction is caused in a power storage device such as a lithium-ion rechargeable battery, and insulation performance between electrodes increases due to closing of holes of the layer. That is, a shutdown function is performed. Furthermore, polyethylene is preferable from the viewpoint of wettability and a shutdown function. High density polyethylene is preferable from the viewpoint of mechanical strength.

When polyolefin used in the polyolefin porous membrane layer is polyethylene and polypropylene, a polyolefin porous membrane layer is preferably a laminated porous membrane layer wherein a polyethylene porous membrane layer and a polypropylene porous membrane layer are laminated.

It is preferable that the void fraction of the polyolefin porous membrane layer is 40 to 80%, and more preferably 50 to 70%. When the void fraction is less than 40%, ionic conductivity tends to decrease. When the void fraction exceeds 80%, strength tends to decrease and shrinkage tends to be caused. Here, the void fraction is a value obtained with the following formula (3).

Void fraction=[1−(M/T)/D]×100 (3)

Basis weight: M (g/cm²), thickness: T (μm), and density: D (g/cm³)
The void fraction means the degree of porosity.

The hole diameter of the polyolefin porous membrane layer is preferably 0.01 to 1 μm which is the average hole diameter determined by the Bubble Point Test. When the average hole diameter is less than 0.01 μm, the impregnating ability of an electrolyte decreases and ionic conductivity tends to decrease. When the average hole diameter exceeds 1 μm, internal short-circuiting tends to be caused.

From the viewpoint of decrease of the thickness of a power storage device A, it is preferable that a polyolefin porous membrane layer is as thin as possible. Concretely, it is preferable that the thickness of the polyolefin porous membrane layer is 5 to 30 μm, and more preferably 10 to 20 μm. When the thickness of the polyolefin porous membrane layer is less than 5 μm, mechanical strength tends to decrease and the handling property deteriorates. When the thickness of the polyolefin porous membrane layer exceeds 30 μm, it is difficult to decrease of the thickness of a power storage device.

A polyolefin porous membrane layer can be obtained such that, for example, polyolefin is melt-extruded to form a film, and the obtained film is stretched to form plural fine cracks at the interior of the film (stretched porous membrane layer). Furthermore, it is also possible to generate a polyolefin porous membrane layer such that fine particles or the like, which can be dissolved in a solvent, are added to polyolefin in advance, and the fine particles are removed by eluting into a solvent subsequent to the formation of a film by melt-extrusion using the polyolefin.

As explained above, a separator of the present invention has a structure wherein a polyolefin porous membrane layer and a fiber layer comprising solvent spun cellulose have been laminated. Therefore, the separator is very excellent in a shutdown function, thermal-shrinking resistance, mechanical strength and ionic conductivity. Accordingly, even at the high temperature atmosphere, the separator hardly deteriorates by an electrolyte which is used for driving a power storage device. In this way, a separator of the present invention is preferably used for a lithium-ion rechargeable battery, a lithium ion capacitor and an electric double-layer capacitor. In the second aspect, the volume of a cavity part of the fiber layer is controlled to be smaller than the volume of a resin part of the polyolefin porous membrane layer. Therefore, after the polyolefin porous membrane layer melts at the meltdown temperature range or more and the melted resin is adsorbed in the cavity part of the fiber layer, no cavity in the fiber layer remains. Therefore, a decrease of resistance originating from a remained cavity of the fiber layer is not caused even after the meltdown of the polyolefin porous membrane layer. Accordingly, a separator of the second aspect is preferably used for a lithium-ion rechargeable battery, a lithium ion capacitor and an electric double-layer capacitor.

When a power storage device is generated using a separator of the present invention, materials used for forming a power storage device such as a positive electrode, a negative electrode and an electrolyte may be selected from any conventionally known materials.

Next, the manufacturing method of the separator of the present invention is described below. However, the present invention is not limited thereto, and it is also possible to manufacture the separator of the present invention using another methods.

First, the manufacturing method of a fiber layer is explained below.

Fibrillated cellulose which has a fiber diameter of 1 μm or less and fiber length of 3 mm or less is dispersed in water. A fiber used in the present invention is a very fine fiber. Therefore it is difficult to disperse the fiber uniformly in the defibration step. It is possible to disperse such a fiber well using a supersonic dispersing machine or a dispersing machine such as a pulper or an agitator. In order to decrease ionic impurities as much as possible, ion-exchanged water is preferably used. The fibrillating method of cellulose can be optionally selected. For example, when beating is conducted, it is possible to use a ball mill, a beater, a Lampen mill, a PFI mill, a SDR (single disk refiner), a DDR (double disk refiner), a high pressure homogenizer, a homo mixer or any other refiner. The beating degree can be optionally selected, and for example, it is preferable that the freeness of the fiber is about 0 to 10 ml.

The fiber dispersion obtained by the aforementioned method is used for making a sheet with a wet-type paper machine such as those of a fourdrinier type, a tanmo type, a cylinder type and an inclined type. Subsequently, the sheet is dehydrated at a dehydrating part which has a continuous wire mesh shape. Among the wet-type paper machines, due to the use of a cylinder type paper machine having two heads for laminating two or more fiber layers, it is possible to obtain a uniform combined fiber layer without pinholes, and boundary tends to be not observed between the laminated layers. After combining the fiber layers, a fiber layer usable in the present invention can be obtained by passing through a drying part such as Yankee type dryer and multi-cylinder dryer.

Next, an adhesive solution is coated on a single surface of a polyolefin porous membrane layer. In the present invention, it is possible to select whether or not an adhesive is used. The coating method of an adhesive solution can be selected optionally. Examples thereof include coating methods such as dip-coating, spray-coat coating, roll-coating, doctor blade coating, gravure coating, and screen printing; and casting methods. After coating, a fiber layer is provided on the polyolefin porous membrane layer, and drying is conducted to obtain a separator in which the fiber layer and the polyolefin porous membrane layer are laminated. It is possible to use an adhesive such that, after drying of an adhesive solution subsequent to coating, the fiber layer and the polyolefin porous membrane layer are laminated with a roll laminator to form a separator. It is also possible to coat an adhesive solution on a fiber layer, and then, a polyolefin porous membrane layer is provided on the adhesive solution to obtain a separator.

In the above method, it is possible to use a substrate. For example, it is possible to use a substrate such that a polyolefin porous membrane layer is provided on the substrate. In such a case, the substrate is removed after drying of an adhesive which is used for laminating the fiber layer and the polyolefin porous membrane layer.

The substrate can be optionally selected. For example, resin films such as polypropylene and polyethylene terephthalate can be used as the substrate. The surface of the substrate may be optionally treated to achieve easy-adhesion or easy-releasing. Among the substrates, a resin film having flexibility are preferably used. When such a resin film is used as a substrate, the surface of a separator can be protected by the resin film, and it is also possible to store and transfer a separator in the form of a rolled sheet wherein a separator is provided on the substrate.

An adhesive usable in the present invention can be optionally selected and used. Examples of the adhesive include ethylene-propylene-diene terpolymer, acrylonitrile-butadiene rubber, fluoro rubber, polyvinyl acetate, polymethyl methacrylate, polyethylene, cellulose nitrate, polyvinylidene fluoride, polypropylene, polytetrafluoroethylene, polytetrafluoroethylene-hexafluoropropylene copolymer, polyvinylidene fluoride-chlorotrifluoroethylene copolymer, styrene-butadiene rubber (SBR) and carboxymethylcellulose (CMC). At least one of the above adhesives can be used in the present invention.

When an adhesive is dissolved in a solvent, any of aqueous solvents and nonaqueous solvents can be used. Examples of the nonaqueous solvents include N-methyl-2-pyrrolidone (NMP), dimethylformamide, dimethylacetamide, acetone, methyl ethyl ketone, cyclohexanone, methyl acetate, methyl acrylate, diethylenetriamine, N,N-dimethylaminopropylamine, ethylene oxide, tetrahydrofuran, methyl alcohol, ethyl alcohol and toluene. As the aqueous solvents, water or the like can be used. The concentration of an adhesive solution is optionally selected, and in general, it is preferably about 1 to 30%, and more preferably about 1 to 15%. The thickness of the coated adhesive is optionally selected, and it is preferably about 0.1 to 2 μm.

It is preferable that the thickness of a separator be as thin as possible. Concretely, the thickness of a separator is preferably 30 μm or less, and more preferably 25 μm or less. When the thickness of the separator exceeds 30 μm, impedance tends to increase since ion migration is inhibited. The lower limit of the thickness of a separator can be selected optionally, and it is preferable that the thickness thereof is 10 μm or more in general.

As described above, a separator of the first aspect and second aspect of the present invention is a thin film, has a shutdown function and has excellent thermal-shrinking resistance, mechanical strength and ionic conductivity. The separator is preferably used for a power storage device such as a lithium-ion rechargeable battery, a lithium ion capacitor and an electric double-layer capacitor.

The aforementioned separator can reduce thermal-shrinking due to the presence of the laminated fiber layer, and can show a shutdown function due to the laminated polyolefin porous membrane layer which may be polyethylene and/or polypropylene or the like.

Furthermore, in the separator of the second aspect of the present invention, the volume of a cavity part of the fiber layer is controlled to be smaller than the volume of a resin part of the polyolefin porous membrane layer. Accordingly, after the polyolefin porous membrane layer melts at the meltdown temperature range or more and the melted resin is adsorbed in a cavity part of the fiber layer, no cavity of the fiber layer is remained. Accordingly, there is no decrease of resistance originating from a remained cavity part of the fiber layer, after occurrence of the meltdown of the polyolefin porous membrane layer.

### EXAMPLES

Hereinafter, a separator of the present invention is explained using examples, but the scope of the present invention is not limited thereto. Additions, omissions, substitutions, and other modifications can be made without departing from the scope of the present invention. The invention is only limited by the scope of the appended claims.

### Example 1

A sheet-like stretched porous membrane layer made of high density polyethylene was prepared wherein the layer had a void fraction of 55%, a thickness of 16 μm, a length of 257 mm, and a width of 182 mm. The sheet-like stretched porous membrane layer was prepared such that high density polyethylene was melt-extruded with T-die to form a polyethylene film, heat treatment for the polyethylene film was performed while the film was transferred in a hot air circling oven, and then the film was drawn between nip rollers. An acetone solution including 3% by mass of a styrene-butadiene rubber (SBR) was coated on the porous membrane layer by the spray-coating method. On the coated surface of the porous membrane layer, a sheet-like fiber layer was laminated. The fiber layer was made of fibrillated solvent spun cellulose having a fiber diameter of 0.5 μm and fiber length of 1 mm, and the fiber layer had a thickness of 10 μm, the density is 0.52 g/cm³ and the air permeability is 8 sec/100 mL. Then, the laminate was dried at 60° C. for two minutes using a Yankee dryer to obtain a separator of the present invention. Here, the aforementioned fiber layer was made using a standard sheet making machine (a wet-type paper machine) which is according to JIS P822. Furthermore, the volume of a cavity part of the fiber layer is 0.32 cm³, and the volume of a resin part of the polyolefin porous membrane layer was 0.34 cm³.

### Example 2

A separator of the present invention was prepared similar to the method of Example 1, except that a stretched porous membrane layer made of high density polyethylene, which had a void fraction of 60%, and a thickness of 12 μm, was used. In the separator, the volume of a resin part of the polyolefin porous membrane layer was 0.22 cm³.

### Example 3

A separator of the present invention was prepared similar to the method of Example 1, except that a stretched porous membrane layer made of high density polypropylene, which had a void fraction of 55%, and a thickness of 16 μm, was used. In the separator, the volume of a resin part of the polyolefin porous membrane layer was 0.34 cm³.

### Example 4

A separator of the present invention was prepared similar to the method of Example 1, except that a fiber layer had a thickness of 11 μm, a density of 0.50 g/cm³ and an air permeability of 8 sec/100 mL, and the fiber layer consisted of two fibers, wherein a fibrillated solvent spun cellulose having a fiber diameter of 0.5 μm and a fiber length of 1 mm and a polyethylene terephthalate fiber having a fiber diameter of 2.5 μm and a fiber length of 6 mm were mixed in a mass ratio of 80:20. In the separator, the volume of a cavity part of the fiber layer was 0.35 cm³.

### Example 5

A separator of the present invention was prepared similar to the method of Example 1, except that a fiber layer had a thickness of 11 μm, a density of 0.80 g/cm³ and an air permeability of 28 sec/100 mL, and the fiber layer consisted of two fibers wherein a fibrillated solvent spun cellulose having a fiber diameter of 0.5 μm and a fiber length of 1 mm and a polyethylene terephthalate fiber having a fiber diameter of 2.5 μm and a fiber length of 6 mm were mixed in a mass ratio of 80:20. In the separator, the volume of a cavity part of the fiber layer was 0.25 cm³.

### Example 6

A separator of the present invention was prepared by a method similar to the method of Example 1, except that a fiber layer had a thickness of 10 μm, a density of 0.49 g/cm³ and an air permeability of 5 sec/100 mL, and the fiber layer consisted of two fibers wherein a fibrillated solvent spun cellulose having a fiber diameter of 0.5 μm and a fiber length of 1 mm and a polyethylene fiber having a fiber diameter of 3 μm and a fiber length of 6 mm were mixed in a mass ratio of 80:20. In the separator, the volume of a cavity part of the fiber layer was 0.47 cm³.

### Example 7

A separator of the present invention was prepared similar to the method of Example 1, except that a fiber layer had a thickness of 11 μm, a density of 0.54 g/cm³ and an air permeability of 8 sec/100 mL, and the fiber layer consisted of three fibers wherein a fibrillated solvent spun cellulose having a fiber diameter of 0.5 μm and an fiber length of 1 mm, a polyethylene terephthalate fiber having a fiber diameter of 2.5 μm and a fiber length of 6 mm, and a fibrillated fully aromatic polyamide having a fiber diameter of 0.2 μm and a fiber length of 0.6 mm were mixed in a mass ratio of 15:60:25. In the separator, the volume of a cavity part of the fiber layer was 0.32 cm³.

### Example 8

A separator of the present invention was prepared similar to the method of Example 1, except that a fiber layer had a thickness of 11 μm, a density of 0.51 g/cm³ and an air permeability of 6 sec/100 mL, and the fiber layer consisted of two fibers wherein a fibrillated solvent spun cellulose having a fiber diameter of 0.5 μm and a fiber length of 1 mm and fibrillated fully aromatic polyamide having a fiber diameter of 0.2 μm and a fiber length of 0.6 mm were mixed in a mass ratio of 80:20. In the separator, the volume of a cavity part of the fiber layer was 0.35 cm³.

### Example 9

A separator of the present invention was prepared similar to the method of Example 1, except that a fiber layer had a thickness of 11 μm, a density of 0.54 g/cm³ and an air permeability of 8 sec/100 mL, and the fiber layer consisted of three fibers wherein a fibrillated solvent spun cellulose having a fiber diameter of 0.5 μm and a fiber length of 1 mm, a polyethylene terephthalate fiber having a fiber diameter of 2.5 μm and a fiber length of 6 mm, and a fibrillated polyphenylene sulfide having a fiber diameter of 0.8 μm and a fiber length of 1.5 mm were mixed in a mass ratio of 15:60:25. In the separator, the volume of a cavity part of the fiber layer was 0.33 cm³.

### Example 10

A separator of the present invention was prepared similar to the method of Example 1, except that a fiber layer had a thickness of 11 μm, a density of 0.54 g/cm³ and an air permeability of 19 sec/100 mL, and the fiber layer consisted of three fibers wherein a fibrillated solvent spun cellulose having a fiber diameter of 0.5 μm and a fiber length of 1 mm, a polyethylene terephthalate fiber having a fiber diameter of 2.5 μm and a fiber length of 6 mm, and a fibrillated polyphenylene sulfide having a fiber diameter of 0.8 μm and a fiber length of 1.5 mm were mixed in a mass ratio of 20:30:50. In the separator, the volume of a cavity part of the fiber layer was 0.35 cm³.

### Example 11

A separator of the present invention was prepared similar to the method of Example 1, except that an aqueous carboxymethylcellulose solution was used as an adhesive and drying was performed at 110° C. for two minutes. The concentration of the adhesive solution was 2% by mass.

### Comparative Example 1

A stretched polyethylene porous film, which had a thickness of 25 μm and was widely used for a lithium-ion rechargeable battery, was used as a separator. The separator was a single layered separator.

### Comparative Example 2

A nonwoven fabric separator made of a cellulose pulp, which had a thickness of 35 μm and was widely used for an electric double-layer capacitor, was used as a separator. The separator was a single layered separator.

Regarding the separators obtained in Examples 1 to 11 and Comparative Examples 1 and 2, the following characteristics were evaluated.

(Thermal Dimensional Stability (Thermal Shrinkage Resistance))

The separators obtained in Examples 1 to 11 and Comparative Examples 1 and 2 were cut to prepare test pieces with a length of 5 cm and a width of 5 cm. Each test piece was inserted between glass plates which had a length of 10 cm, a width of 10 cm and a thickness of 5 mm. The generated laminates were provided in an aluminum vat such that they were placed evenly. Heating of the laminates were performed at 200° C. for 30 minutes to obtain a dimensional change rate after heating. The evaluation results are shown in Table 1.

TABLE 1

| | Dimensional change |
|---|---|
| | rate after heating (%) |
| Example 1 | −0.1 |
| Example 2 | −0.2 |
| Example 3 | −0.1 |
| Example 4 | −0.2 |
| Example 5 | −0.1 |
| Example 6 | −0.1 |
| Example 7 | −0.1 |
| Example 8 | −0.1 |
| Example 9 | −0.1 |
| Example 10 | −0.1 |
| Example 11 | −0.1 |
| Comparative | Evaluation was not performed |
| Example 1 | due to the dissolution of a separator |
| Comparative | −0.1 |
| Example 2 | |

The separators of the present invention had excellent dimensional stability even at the meltdown temperature range of the polyolefin porous membrane layer. However, the separator of Comparative Example 1 was completely dissolved at 200° C. and the shape of the separator was not maintained at all.

(Shutdown Function)

Regarding the separators obtained in Examples 1 to 11 and Comparative Examples 1 and 2, simple cells were formed using a positive electrode and a negative electrode, and impedance after heating was determined at a temperature of 30° C. and 160° C. which was the temperature of the shutdown temperature range. As a measuring equipment, an electrochemical interface/frequency response analyzer (Solartron) was used. Here, when the simple cells were formed, an activated carbon electrode for an electric double-layer capacitor (manufactured by Hohsen Corporation, product name: activated carbon electrode for an electric double-layer capacitor) was used as an electrode. Furthermore, a solution which was a propylene carbonate including 1 mol/L of tetraethylammonium tetrafluoroborate (commercially available by Kishida Reagents Chemical Co., Ltd) was used as an electrolyte. The evaluation results are shown in Table 2.

TABLE 2

Impedance (Ω)

| | | After heating at |
|---|---|---|
| | 30° C. | 160° C. |
| Example 1 | 52.3 | 4.82 × 10⁵ |
| Example 2 | 52.5 | 4.72 × 10⁵ |
| Example 3 | 51.3 | 4.79 × 10⁵ |
| Example 4 | 53.3 | 4.84 × 10⁵ |
| Example 5 | 52.1 | 4.79 × 10⁵ |
| Example 6 | 52.4 | 4.79 × 10⁵ |
| Example 7 | 52.5 | 4.78 × 10⁵ |
| Example 8 | 52.2 | 4.81 × 10⁵ |
| Example 9 | 52.3 | 4.82 × 10⁵ |
| Example 10 | 52.4 | 4.82 × 10⁵ |
| Example 11 | 52.4 | 4.77 × 10⁵ |
| Comparative Example 1 | 51.3 | 4.80 × 10⁵ |
| Comparative Example 2 | 52.3 | 52.1 |

The separators of the present invention had a shutdown function. However, the separator of Comparative Example 2 had no change of impedance even after heating at 160° C., and therefore the separator did not show a shutdown function.

(Discharge Capacity Change by Long-Term High Temperature Test)

For each of the separators obtained in Examples 1 to 11 and Comparative Examples 1 and 2, a hundred rolled-up type cells were generated, subsequent to the formation of electric double-layer capacitors wherein a positive electrode, a negative electrode and the separators were used. As the electrode, an activated carbon electrode for an electric double-layer capacitor (manufactured by Hohsen Corporation, product name: activated carbon electrode for an electric double-layer capacitor) was used. Furthermore, a solution which was propylene carbonate including 1 mol/L of tetraethylammonium tetrafluoroborate (commercially available by Kishida Reagents Chemical Co., Ltd) was used as an electrolyte. Discharge capacity of the generated rolled-up type cells were evaluated with a LCR meter at the timing of the initial stage, after a 2000 hours test, and a 4000 hours test. Then, the change (decrease) of discharge capacity after the long-term high temperature test was evaluated. Test conditions of the test were 80° C. and 2.5 V was applied. The evaluation results are shown in Table 3.

TABLE 3

| | Discharge capacity (F) | | |
|---|---|---|---|
| | | After 2000 hours | After 4000 hours |
| | Initial | passed | passed |
| Example 1 | 9.8 | 9.5 | 9.2 |
| Example 2 | 10.5 | 10.4 | 10.1 |
| Example 3 | 10.2 | 9.8 | 9.2 |
| Example 4 | 9.9 | 9.4 | 8.8 |
| Example 5 | 10.0 | 9.5 | 9.0 |
| Example 6 | 10.1 | 9.9 | 9.7 |
| Example 7 | 10.4 | 10.1 | 9.7 |
| Example 8 | 9.9 | 9.8 | 9.2 |
| Example 9 | 10.0 | 9.7 | 9.0 |
| Example 10 | 10.2 | 9.9 | 9.1 |
| Example 11 | 9.9 | 9.8 | 9.2 |
| Comparative Example 1 | 9.8 | 9.7 | 9.3 |
| Comparative Example 2 | 9.8 | 9.7 | 2.5 |

As it apparent from the results of Table 3, it was confirmed that the electric double-layer capacitors obtained using the separator of the present invention maintained sufficient discharge capacity even after application of 2.5 V of voltage at 80° C. On the other hand, the electric double-layer capacitor using the separator of Comparative Example 2 showed extremely poor characteristics. The capacitor thereof showed a large decrease of discharge capacity, and there was a capacitor which caused an internal short-circuit at the initial stage.

(Examples of the Second Aspect)

### Example 12

A sheet-like stretched porous membrane layer made of high density polyethylene was prepared wherein the layer had a void fraction of 55%, a thickness of 16 μm, a length of 257 mm, a width of 182 mm, and a basis weight of 0.000691 g/cm². The volume of a resin part of the porous membrane layer was 0.34 cm³. The stretched porous membrane layer made of high density polyethylene was prepared such that high density polyethylene (specific gravity: 0.96) was melt-extruded with T-die to form a polyethylene film, heat treatment for the polyethylene film was performed while the film was transferred in a hot air circling oven, and then the film was extended between nip rollers. On the porous membrane layer, an acetone solution including 3% by mass of a styrene-butadiene rubber (SBR) was coated by the spray-coating method. On the coated surface of the porous membrane layer, a sheet-like fiber layer was laminated wherein the fiber layer had the same shape as the above porous membrane layer and was made of fibrillated solvent spun cellulose (specific gravity: 1.6) having a fiber diameter of 0.5 μm and a fiber length of 1 mm. The fiber layer had a thickness of 10 μm, a density of 0.52 g/cm³, and an air permeability of 8 sec/100 mL, and the volume of a cavity part of the fiber layer was 0.32 cm³. The laminated sheet was dried at 60° C. for two minutes using a Yankee dryer to obtain a separator of the present invention. Here, the aforementioned fiber layer was made using a standard sheet making machine (a wet-type paper machine) which is according to JIS P822. The volume of a resin part of the stretched porous membrane layer made of high density polyethylene was 0.34 cm³, and it was larger than the volume of a cavity part of the fiber layer is 0.32 cm³.

The volume of a resin part of the polyolefin porous membrane layer was determined by the following formula.

The volume of a resin part (cm³)=L×W×T1×[(M/T2)/D]=25.7×18.2×0.0016×[(0.000691/0.0016)/0.96]=0.34 cm³

The volume of a cavity part of the fiber layer was determined by the following formula. The basis weight M (g/cm²) can be obtained from the density (g/cm³) and the thickness. (Basis weight=density×thickness)

The volume of a cavity part (cm³)=L×W×T1×[1−(M/T2)/D]=25.7×18.2×0.001×[1−(0.00052/0.001)/1.6]=0.32 cm³

### Example 13

A separator of the present invention was prepared similar to the method of Example 12, except that a stretched porous membrane layer made of high density polyethylene (specific gravity: 0.96), which had a void fraction of 50%, a thickness of 16 μm, a length of 257 mm, a width of 182 mm, a basis weight of 0.000768 g/cm² and a volume of a resin part of 0.37 cm³, was used. The volume of a resin part of the polyolefin porous membrane layer was determined as shown below.

The volume of a resin part (cm³)=L×W×T1×[(M/T2)/D]=25.7×18.2×0.0016×[(0.000768/0.0016)/0.96]=0.37 cm³

### Example 14

A separator of the present invention was prepared similar to the method of Example 12, except that a stretched porous membrane layer made of high density polypropylene (specific gravity: 0.96), which had a void fraction of 45%, a thickness of 16 μm, a length of 257 mm, a width of 182 mm, a basis weight of 0.000845 g/cm² and a volume of a resin part of 0.41 cm³ was used. The volume of a resin part of the polyolefin porous membrane layer was determined as shown below.

The volume of a resin part (cm³)=L×W×T1×[(M/T2)/D]=25.7×18.2×0.0016×[(0.000845/0.0016)/0.96]=0.41 cm³

### Example 15

A separator of the present invention was prepared similar to the method of Example 12, except that a fiber layer had a thickness of 10 μm, a density of 0.50 g/cm³, an air permeability of 8 sec/100 mL and a volume of a cavity part of 0.32 cm³, and the fiber layer consisted of two fibers wherein a fibrillated solvent spun cellulose (specific gravity: 1.6) having a fiber diameter of 0.5 μm and a fiber length of 1 mm and a polyethylene terephthalate fiber (specific gravity: 1.4) having a fiber diameter of 2.5 μm and a fiber length of 6 mm were mixed in a mass ratio of 80:20. The volume of a cavity part of the fiber layer was determined as shown below.

The volume of a cavity part (cm³)=L×W×T1×[1−(M/T2)/D]=25.7×18.2×0.001×[140.0005/0.001)/(1.6×0.8+1.4×0.2)]=0.32 cm³

### Example 16

A separator of the present invention was prepared similar to the method of Example 12, except that a fiber layer had a thickness of 11 μm, a density of 0.80 g/cm³, an air permeability of 28 sec/100 mL and a volume of a cavity part of 0.25 cm³, and the fiber layer consisted of two fibers wherein a fibrillated solvent spun cellulose (specific gravity: 1.6) having a fiber diameter of 0.5 μm and a fiber length of 1 mm and a polyethylene terephthalate fiber (specific gravity: 1.4) having a fiber diameter of 2.5 μm and a fiber length of 6 mm were mixed in a mass ratio of 80:20. The volume of a cavity part of the fiber layer was determined as shown below.

The volume of a cavity part (cm³)=L×W×T1×[1−(M/T2)/D]=25.7×18.2×0.0011×[140.00088/0.0011)/(1.6×0.8+1.4×0.2)]=0.25 cm³

### Example 17

A separator of the present invention was prepared similar to the method of Example 12, except that a fiber layer had a thickness of 10 μm, a density of 0.49 g/cm³, an air permeability of 5 sec/100 mL and an volume of a cavity part of 0.31 cm³, and the fiber layer consisted of two fibers wherein a fibrillated solvent spun cellulose (specific gravity: 1.6) having a fiber diameter of 0.5 μm and a fiber length of 1 mm and a polyethylene fiber (specific gravity: 0.94) having a fiber diameter of 3 μm and a fiber length of 6 mm were mixed in a mass ratio of 80:20. The volume of a cavity part of the fiber layer was determined as shown below.

The volume of a cavity part (cm³)=L×W×T1×[1−(M/T2)/D]=25.7×18.2×0.001×[1−(0.00049/0.001)/(1.6×0.8+0.94×0.2)]=0.31 cm³

### Example 18

A separator of the present invention was prepared similar to the method of Example 12, except that a fiber layer had a thickness of 10 μm, a density of 0.54 g/cm³, an air permeability of 8 sec/100 mL and a volume of a cavity part of 0.30 cm³, and the fiber layer consisted of three fibers wherein a fibrillated solvent spun cellulose (specific gravity: 1.6) having a fiber diameter of 0.5 μm and a fiber length of 1 mm, a polyethylene terephthalate fiber (specific gravity: 1.4) having a fiber diameter of 2.5 μm and a fiber length of 6 mm and fibrillated fully aromatic polyamide (specific gravity: 1.44) having a fiber diameter of 0.2 μm and a fiber length of 0.6 mm were mixed in a mass ratio of 60:15:25. The volume of a cavity part of the fiber layer was determined as shown below.

The volume of a cavity part (cm³)=L×W×T1×[1−(M/T2)/D]=25.7×18.2×0.001×[140.00054/0.001)/(1.6×0.6+1.4×0.15+1.44×0.25)]=0.30 cm³

### Example 19

A separator of the present invention was prepared similar to the method of Example 12, except that a fiber layer had a thickness of 10 μm, a density of 0.51 g/cm³, an air permeability of 6 sec/100 mL and a volume of a cavity part of 0.32 cm³, and the fiber layer consisted of two fibers wherein a fibrillated solvent spun cellulose (specific gravity: 1.6) having a fiber diameter of 0.5 μm and a fiber length of 1 mm and fibrillated fully aromatic polyamide (specific gravity: 1.44) having a fiber diameter of 0.2 μm and a fiber length of 0.6 mm were mixed in a mass ratio of 80:20. The volume of a cavity part of the fiber layer was determined as shown below.

The volume of a cavity part (cm³)=L×W×T1×[1−(M/T2)/D]=25.7×18.2×0.001×[140.00051/0.001)/(1.6×0.8+1.44×0.2)]=0.32 cm³

### Example 20

A separator of the present invention was prepared similar to the method of Example 12, except that a fiber layer had a thickness of 10 μm, a density of 0.54 g/cm³, an air permeability of 8 sec/100 mL and a volume of a cavity part of 0.31 cm³, and the fiber layer consisted of three fibers wherein a fibrillated solvent spun cellulose (specific gravity: 1.6) having a fiber diameter of 0.5 μm and a fiber length of 1 mm, a polyethylene terephthalate fiber (specific gravity: 1.4) having a fiber diameter of 2.5 μm and a fiber length of 6 mm, and a fibrillated polyphenylene sulfide (specific gravity: 1.8) having a fiber diameter of 0.8 μm and a fiber length of 1.5 mm were mixed in a mass ratio of 60:15:25. The volume of a cavity part of the fiber layer was determined as shown below.

The volume of a cavity part (cm³)=L×W×T1×[1−(M/T2)/D]=25.7×18.2×0.001×[140.00054/0.001)/(1.6×0.6+1.4×0.15+1.8×0.25)]=0.31 cm³

### Example 21

A separator of the present invention was prepared similar to the method of Example 12, except that a fiber layer had an thickness of 10 μm, a density of 0.54 g/cm³, an air permeability of 19 sec/100 mL and a volume of a cavity part of 0.32 cm³, and the fiber layer consisted of three fibers wherein a fibrillated solvent spun cellulose (specific gravity: 1.6) having a fiber diameter of 0.5 μm and a fiber length of 1 mm, a polyethylene terephthalate fiber (specific gravity: 1.4) having a fiber diameter of 2.5 μm and a fiber length of 6 mm, and a fibrillated polyphenylene sulfide (specific gravity: 1.8) having a fiber diameter of 0.8 μm and a fiber length of 1.5 mm were mixed in a mass ratio of 30:20:50. The volume of a cavity part of the fiber layer was determined as shown below.

The volume of a cavity part (cm³)=L×W×T1×[1−(M/T2)/D]=25.7×18.2×0.001×[140.00054/0.001)/(1.6×0.3+1.4×0.2+1.8×0.5)]=0.32 cm³

### Example 22

A separator of the present invention was prepared similar to the method of Example 12, except that an aqueous carboxymethylcellulose solution was used as an adhesive instead of the acetone solution including SBR, and drying was performed at 110° C. for two minutes. The concentration of the aqueous carboxymethylcellulose solution was 2% by mass.

### Reference Example 1

On a stretched porous membrane layer made of high density polyethylene, which had a void fraction of 55%, a thickness of 16 μm, a length of 257 mm, a width of 182 mm, a basis weight of 0.000691 g/cm², and a volume of a resin part of 0.34 cm³, an acetone solution including 3% by mass of a styrene-butadiene rubber (SBR) was coated. On the coated surface of the porous membrane layer, a fiber layer was laminated wherein the fiber layer had the same shape as the above porous membrane layer and was made of a fibrillated solvent spun cellulose (specific gravity: 1.6) having a fiber diameter of 0.5 μm and a fiber length of 1 mm, and the fiber layer had a thickness of 10 μm, a density of 0.31 g/cm³, an air permeability of 8 sec/100 mL, and a volume of a cavity part of 0.38 cm³. Then, the laminated sheet was dried at 60° C. to generate a separator used for comparison. The volume of a resin part of the polyolefin porous membrane layer made of high density polyethylene was 0.34 cm³, and it was smaller than the volume of a cavity part of the fiber layer is 0.38 cm³. The volume of a resin part of the polyolefin porous membrane layer made of high density polyethylene was determined similar to Example 12.

The volume of a cavity part (cm³)=L×W×T1×[1−(M/T2)/D]=25.7×18.2×0.001×[140.00031/0.001)/1.6]=0.38 cm³

Regarding the separators obtained in Examples 12 to 22 and Reference Example 1, following characteristics were evaluated.

(Thermal Dimensional Stability (Thermal Shrinkage Resistance))

The separators obtained in Examples 12 to 22 and Reference Example 1 were cut to prepare test pieces with a length of 5 cm and a width of 5 cm. Each test piece was inserted between glass plates which had a length of 10 cm, a width of 10 cm and a thickness of 5 mm. The generated laminates were provided in an aluminum vat such that they were placed in level. Heating of the laminates were performed at 200° C. for 30 minutes to obtain a dimensional change rate after heating. The evaluation results are shown in Table 4.

TABLE 4

| | Dimensional change rate After |
|---|---|
| | heating (%) |
| Example 12 | −0.1 |
| Example 13 | −0.2 |
| Example 14 | −0.1 |
| Example 15 | −0.2 |
| Example 16 | −0.1 |
| Example 17 | −0.1 |
| Example 18 | −0.1 |
| Example 19 | −0.1 |
| Example 20 | −0.1 |
| Example 21 | −0.1 |
| Example 22 | −0.1 |
| Reference Example 1 | −0.1 |

As it apparently from Table 4, the separators of the present invention showed excellent dimensional stability even at the meltdown temperature range of the polyolefin porous membrane layer. The separator of the Reference Example 1 also showed excellent dimensional stability.

(Shutdown Function)

Regarding the separators obtained in Examples 12 to 22 and Reference Example 1, simple cells were generated using a positive electrode and a negative electrode, and impedance was measured for each cell after maintained at the temperature of 30° C., after heating at 160° C. which was the shutdown temperature range, and after heating at 200° C. which was the meltdown temperature range. When the simple cells were formed, an activated carbon electrode for an electric double-layer capacitor (manufactured by Hohsen Corporation, product name: activated carbon electrode for an electric double-layer capacitor) was used as an electrode. Furthermore, a solution which was propylene carbonate including 1 mol/L of tetraethylammonium tetrafluoroborate (commercially available by Kishida Reagents Chemical Co., Ltd) was used as an electrolyte. The evaluation results are shown in Table 5.

TABLE 5

| | Impedance (Ω) | | |
|---|---|---|---|
| | | After heating | After heating |
| | 30° C. | at 160° C. | at 200° C. |
| Example 12 | 52.3 | 4.82 × 10⁵ | 4.84 × 10⁵ |
| Example 13 | 52.5 | 4.72 × 10⁵ | 4.74 × 10⁵ |
| Example 14 | 51.3 | 4.79 × 10⁵ | 4.81 × 10⁵ |
| Example 15 | 53.3 | 4.84 × 10⁵ | 4.85 × 10⁵ |
| Example 16 | 52.1 | 4.79 × 10⁵ | 4.80 × 10⁵ |
| Example 17 | 52.4 | 4.79 × 10⁵ | 4.79 × 10⁵ |
| Example 18 | 52.5 | 4.78 × 10⁵ | 4.79 × 10⁵ |
| Example 19 | 52.2 | 4.81 × 10⁵ | 4.83 × 10⁵ |
| Example 20 | 52.3 | 4.82 × 10⁵ | 4.85 × 10⁵ |
| Example 21 | 52.4 | 4.82 × 10⁵ | 4.85 × 10⁵ |
| Example 22 | 52.4 | 4.77 × 10⁵ | 4.79 × 10⁵ |
| Reference | 52.1 | 4.80 × 10⁵ | 6.34 × 10⁴ |
| Example 1 | | | |

As it apparent from Table 5, the separators of the present invention had a shutdown function. On the other hand, regarding the separator of Reference Example, the separator showed decreased resistance, and ionic conductivity was started again after shutdown was caused wherein a polyolefin porous membrane layer melts (after heating at 200° C.). Accordingly, it was confirmed that the separator of Reference Example can be adopted for general use without problems, but the separator cannot be used preferably in such a case that high performance is required.

(Discharge Capacity Change by Long-Term High Temperature Test)

For each of the separators obtained in Examples 12 to 22 and Reference Example 1, a hundred rolled-up type cells were generated, subsequent to the formation of electric double-layer capacitors wherein a positive electrode, a negative electrode and the separators were used. An activated carbon electrode for an electric double-layer capacitor (manufactured by Hohsen Corporation, product name: activated carbon electrode for an electric double-layer capacitor) was used when the rolled-up type cells were used. A solution which was propylene carbonate including 1 mol/L of tetraethylammonium tetrafluoroborate (commercially available by Kishida Reagents Chemical Co., Ltd) was used as an electrolyte. The discharge capacity of the generated rolled-up type cells were evaluated with a LCR meter at the timing of the initial stage, after 2000 hours test, and 4000 hours test. Then, the change (decrease) of discharge capacity after the long-term high temperature test was evaluated. The test conditions were 80° C. and 2.5 V was applied. The evaluation results are shown in Table 6.

TABLE 6

| | Discharge capacity (F) | | |
|---|---|---|---|
| | | After 2000 hours | After 4000 hours |
| | Initial | passed | passed |
| Example 12 | 9.8 | 9.5 | 9.2 |
| Example 13 | 10.5 | 10.4 | 10.1 |
| Example 14 | 10.2 | 9.8 | 9.2 |
| Example 15 | 9.9 | 9.4 | 8.8 |
| Example 16 | 10.0 | 9.5 | 9.0 |
| Example 17 | 10.1 | 9.9 | 9.7 |
| Example 18 | 10.4 | 10.1 | 9.7 |
| Example 19 | 9.9 | 9.8 | 9.2 |
| Example 20 | 10.0 | 9.7 | 9.0 |
| Example 21 | 10.2 | 9.9 | 9.1 |
| Example 22 | 9.9 | 9.8 | 9.2 |
| Reference | 9.8 | 9.7 | 9.3 |
| Example 1 | | | |

As it apparent from the results of Table 6, it was confirmed that the electric double-layer capacitors obtained using the separator of the present invention maintained sufficient discharge capacity even after application of 2.5 V at 80° C. Furthermore, regarding discharge capacity, the capacitor using the separator of Reference Example maintained suitable discharge capacity.

What is claimed is:

1. A separator of a power storage device, which is a laminate of a polyolefin porous membrane layer and a fiber layer comprising a solvent spun cellulose.

2. The separator of a power storage device according to claim 1, wherein the fiber layer comprises a thermoplastic synthetic fiber A.

3. The separator of a power storage device according to claim 1, wherein the fiber layer comprises a heat resistance synthetic fiber B.

4. The separator of a power storage device according to claim 1, wherein the solvent spun cellulose is a fibrillated cellulose having a fiber diameter of 1 μm or less and a fiber length of 3 mm or less.

5. The separator of a power storage device according to claim 2, wherein the thermoplastic synthetic fiber A is polyester or polyolefin.

6. The separator of a power storage device according to claim 2, wherein the fiber layer satisfies a compounding ratio of 70 to 95% by mass of the solvent spun cellulose and 5 to 30% by mass of the thermoplastic synthetic fiber A.

7. The separator of a power storage device according to claim 2, wherein the thermoplastic synthetic fiber A has a fiber diameter of 5 μm or less and a fiber length of 10 mm or less.

8. The separator of a power storage device according to claim 3, wherein the fiber B is made of at least one material selected from the group consisting of fully aromatic polyamide, semi-aromatic polyamide, fully aromatic polyester, polyphenylene sulfide, poly-p-phenylene-benzobisoxazole, polyimide, polyamide-imide, polyether ether ketone, polybenzimidazole and polyacetal.

9. The separator of a power storage device according to claim 3, wherein a compounding ratio of the fiber layer is 5 to 90% by mass of the solvent spun cellulose, 5 to 30% by mass of the thermoplastic synthetic fiber A, and 5 to 90% by mass of the heat resistance synthetic fiber B.

10. The separator of a power storage device according to claim 3, wherein the heat resistance synthetic fiber B is a fibrillated fiber having a fiber diameter of 1 μm or less and a fiber length of 10 mm or less.

11. The separator of a power storage device according to claim 1, wherein a thickness of the fiber layer is 30 nm or less.

12. The separator of a power storage device according to claim 1, wherein a density of the fiber layer is 0.2 to 0.9 g/cm³.

13. The separator of a power storage device according to claim 1, wherein an air permeability of the fiber layer is 100 sec/100 ml or less.

14. The separator of a power storage device according to claim 1, wherein the polyolefin porous membrane layer is made of polyethylene, polypropylene or a combination of polyethylene and polypropylene.

15. The separator of a power storage device according to claim 1, wherein the fiber layer and the polyolefin porous membrane layer are adhered with each other with an adhesive.

16. The separator of a power storage device according to claim 1, wherein the power storage device is a lithium-ion rechargeable battery, a lithium ion capacitor or an electric double-layer capacitor.

17. A separator of a power storage device, wherein the separator is a laminate of a polyolefin porous membrane layer and a fiber layer comprising a solvent spun cellulose, and a volume of a cavity part of the fiber layer is smaller than a volume of a resin part of the polyolefin porous membrane layer.

18. The separator of a power storage device according to claim 17, wherein the fiber layer comprises a thermoplastic synthetic fiber A.

19. The separator of a power storage device according to claim 17, wherein the fiber layer comprises a heat resistance synthetic fiber B.

20. The separator of a power storage device according to claim 17, wherein the solvent spun cellulose is a fibrillated cellulose having a fiber diameter of 1 μm or less and a fiber length of 3 mm or less.

21. The separator of a power storage device according to claim 18, wherein the thermoplastic synthetic fiber A is polyester or polyolefin.

22. The separator of a power storage device according to claim 18, wherein the fiber layer satisfies a compounding ratio of 70 to 95% by mass of the solvent spun cellulose and 5 to 30% by mass of the thermoplastic synthetic fiber A.

23. The separator of a power storage device according to claim 18, wherein the thermoplastic synthetic fiber A has a fiber diameter of 5 μm or less and a fiber length of 10 mm or less.

24. The separator of a power storage device according to claim 19, wherein the fiber B is made of at least one material selected from the group consisting of fully aromatic polyamide, semi-aromatic polyamide, fully aromatic polyester, polyphenylene sulfide, poly-p-phenylene-benzobisoxazole, polyimide, polyamide-imide, polyether ether ketone, polybenzimidazole and polyacetal.

25. The separator of a power storage device according to claim 19, wherein a compounding ratio of the fiber layer is 5 to 90% by mass of the solvent spun cellulose, 5 to 30% by mass of the thermoplastic synthetic fiber A, and 5 to 90% by mass of the heat resistance synthetic fiber B.

26. The separator of a power storage device according to claim 19, wherein the heat resistance synthetic fiber B is a fibrillated fiber having a fiber diameter of 1 μm or less and a fiber length of 10 mm or less.

27. The separator of a power storage device according to claim 17, wherein a thickness of the fiber layer is 30 nm or less.

28. The separator of a power storage device according to claim 17, wherein a density of the fiber layer is 0.2 to 0.9 g/cm³.

29. The separator of a power storage device according to claim 17, wherein an air permeability of the fiber layer is 100 sec/100 ml or less.

30. The separator of a power storage device according to claim 17, wherein the polyolefin porous membrane layer is made of polyethylene, polypropylene or a combination of polyethylene and polypropylene.

31. The separator of a power storage device according to claim 17, wherein the fiber layer and the polyolefin porous membrane layer are adhered with each other with an adhesive.

32. The separator of a power storage device according to claim 17, wherein the power storage device is a lithium-ion rechargeable battery, a lithium ion capacitor or an electric double-layer capacitor.
